(19) United States
(12) Patent Application Publication
(10) Pub. No.: US 2025/0314831 A1
(43) Pub. Date: Oct. 9, 2025

(54) Optically Efficient Silicon Nitride Edge Couplers In Photonic Integrated Circuits

(71) Applicant: Aayuna, Inc., Allentown, PA (US)

(72) Inventors: Kalpendu Shastri, Orefield, PA (US); Sriram Tyagarajan, Macungie, PA (US); Ravinder Kachru, San Jose, CA (US); David Snyder, Coopersburg, PA (US); Anujit Shastri, Saratoga, CA (US); Rao Yelamarty, Allentown, PA (US)

(73) Assignee: Aayuna, Inc., Allentown, PA (US)

(21) Appl. No.: 18/863,084

(22) PCT Filed: May 4, 2023
(86) PCT No.: PCT/US2023/020963

§ 371 Date: Nov. 5, 2024

Related U.S. Application Data
(60) Provisional application No. 63/339,213, filed on May 6, 2022.

(51) Int. Cl. G02B 6/30

(52) U.S. Cl. CPC G02B 6/305

(57) ABSTRACT

A photonic integrated circuit (PIC) includes one or more silicon nitride edge couplers directly formed on exposed portions of the buried oxide layer. Directly forming the SiN edge couplers on the highly-planar buried oxide layer provides structures with significantly reduced minimal dimension possibilities (as compared to SiN edge couplers within the PIC oxide stack), allowing for a beam emitted from the “SiN-on-box” coupler to exhibit a mode field diameter of larger size than associated with conventional SiN edge couplers positioned on dielectric over the silicon waveguide layer.

### CROSS-REFERENCE TO RELATED APPLICATIONS

This application claims priority from U.S. Provisional Application No. 63/339/213, filed May 6, 2022 and incorporated herein by reference.

### TECHNICAL FIELD

The present invention relates to the field of photonic integrated circuits (PICs) and, more particularly, to providing efficient optical coupling between a PIC and external optical waveguides (e.g., optical fibers).

### BACKGROUND

Advances continue to be made regarding the use of silicon-based integrated optical circuits (also referred to as “photonic integrated circuits”, “photonic ICs”, or simply “PICs”) as a generic platform in a wide range of applications from data communications to sensing systems. The ability to use conventional CMOS-compatible wafer-scale fabrication techniques allows for high-density PICs to be formed for relatively low cost.

Inasmuch as silicon has a high refractive index, a single mode silicon waveguide as fabricated in a PIC exhibits a sub-micron mode size. When needing to couple an optical signal from such a silicon waveguide integrated within a PIC to an external signal path (typically, a single mode optical fiber), the waveguide typically terminates along a sidewall (edge) surface of the PIC, with an intermediate free-space coupler used to improve the coupling efficiency between the sub-micron mode size of the waveguide and a several-micron (e.g., 10 μm) mode field diameter (MFD) of a conventional single mode fiber.

A technique to further improve the coupling efficiency between the sub-micron mode size of the PIC-based silicon waveguides and the several-micron MFD external signal paths (such as optical fibers) is to form an inverse taper along a terminal portion of the silicon waveguide. In particular, an inverse taper involves a reduction in waveguide width near the interface with the single mode fiber. Reduction in waveguide width expands the mode into the surrounding silica (SiO₂) and hence propagation of an expanded beam.

A current approach to improving coupling efficiency is based upon the use of a plurality of silicon nitride (SiN) waveguides disposed within separate layers of the PIC structure to create a type of “vertical” optical connector based upon evanescent field coupling between the conventional silicon waveguide and the SiN material. The several SiN waveguides all terminate at the same edge of the PIC and are spaced vertically and horizontally within the dielectric material forming PIC structure so that the collective group of beams exiting the PIC mimic the form of a circular composite mode in the far field, preferred for improved coupling into a fiber core region.

A problem with this arrangement, however, relates to the planarity of the layers of dielectric material upon which the SiN edge waveguides are formed. In particular, the need for several processing steps to be performed prior to forming the SiN edge waveguides limits the planarity of the surface upon which the SiN waveguides are formed. For example, a minimal value for a critical dimension (CD) of the SiN waveguides (in particular, the width of the endface of the waveguide along the edge of the PIC) is on the order of about 300 nm.

Inasmuch as the MFD of an optical beam is inversely proportional to the waveguiding dimensions, this relatively large “minimal” CD value results in a small mode field diameter, which is difficult to couple into the mating optical fiber.

### SUMMARY OF THE INVENTION

The needs remaining in the art are addressed by the present invention, which relates to providing efficient optical coupling between a PIC and external optical waveguides (e.g., optical fibers) by forming one or more SiN edge waveguides (hereinafter referred to as “SiN edge couplers”) directly on a buried oxide layer. Since the buried oxide layer is the initial semiconductor layer formed on the provided substrate, its planarity is superior to that of other layers thereafter disposed to form the PIC structure. The improved planarity results in the buried oxide layer exhibiting a much lower CD than the rest of the PIC structure and allows for a SiN edge coupler with a much smaller width (and thus a larger MFD) than possible with the vertical coupling arrangement of the prior art.

In exemplary embodiments of the present invention, a SiN edge coupler is formed by removing a portion of the silicon device layer formed on the buried oxide (BOX) layer and then depositing the silicon nitride directly in the exposed areas. The patterning and etching of the silicon device layer is controlled to expose areas on the periphery (edges) of the PIC that are designated for optical coupling. Directly forming the SiN edge couplers on the buried oxide provides structures of with significantly reduced minimal dimension possibilities, allowing for a width of an edge termination to be no greater than about 100 nm (as opposed to 300 nm or more for prior art SiN edge couplers disposed vertically above the silicon device layer). By forming the SiN edge couplers within the same layer as that used for the optical waveguides, a planar arrangement may be created to provide evanescent coupling from the silicon waveguide to the SiN edge couplers. The silicon waveguides and the SiN edge couplers may be formed to include tapered regions to increase the efficiency of the evanescent coupling.

Various embodiments of the present invention may use a multiple number of SiN edge couplers in combination with the silicon waveguide, where the use of a number of spaced-apart SiN edge couplers is found to improve the “fill” of the core region of a mating optical fiber. Moreover, additional embodiments of the present invention may use another SiN edge coupler disposed above the silicon device layer, as in the prior art. Again, the use of more than one coupler is found to increase the fill of the core region. The additional vertically-positioned SiN edge coupler (or set of couplers) may be formed using a conventional technique.

An exemplary embodiment of the present invention may take the form of an optical device including a substrate, a covering oxide layer (buried oxide) and a silicon device layer formed on the buried oxide. The semiconductor substrate is defined as including opposing side edges and the oxide layer is formed on the substrate in a manner to extend the opposing side edges. The silicon device layer is processed to include at least one optical waveguide, with at least a portion of the silicon device layer removed along a side edge to expose the underlying oxide layer. The optical device further comprises one or more silicon nitride edge couplers for providing an optical signal path into and out of the optical device, the silicon nitride edge coupler(s) disposed on the exposed portions of oxide layer along opposing side edges and in proximity with the at least one optical waveguide to provide evanescent coupling therebetween, the silicon nitride coupler and the optical waveguide having a co-planar geometry.

Another embodiment of the present invention may take the form of method of forming an optical device, comprising the steps of: (1) providing a semiconductor substrate defining as including opposing side edges; (2) forming an oxide layer of predetermined height over the semiconductor substrate and covering the semiconductor substrate to further extend the side edges upward; (3) forming a relatively thin silicon device layer over the oxide layer, the relatively thin silicon device layer including at least one optical waveguide; (4) patterning and etching defined regions of the silicon device layer along side edges thereof to expose a top surface of the underlying oxide layer, the defined regions in proximity to the at least one optical waveguide; and (5) depositing silicon nitride in the patterned and etched defined regions to form at least one silicon nitride edge coupler, providing evanescent coupling with the at least one optical waveguide into and out of the optical device.

Other and further embodiments of the present invention will become apparent during the course of the following discussion and by reference to the accompanying drawings.

### BRIEF DESCRIPTION OF THE DRAWINGS

Referring now to the drawings, where like numerals represent like elements in several views:

FIG. 1 illustrates an exemplary photonic integrated circuit (PIC) structure include SiN edge couplers formed directly on the buried oxide layer of the structure in accordance with the principles of the present invention;

FIG. 2 is an end view of the structure of FIG. 1;

FIG. 3 is a top-down view of a portion of a silicon device layer within the PIC structure;

FIG. 4 shows another embodiment of the present invention, in this case using a second silicon nitride edge coupler formed in the dielectric material covering the original edge coupler;

FIG. 5 is an end view of the embodiment of FIG. 4;

FIG. 6 illustrates yet another embodiment of the present invention, in this case a first pair of edge couplers formed on the oxide layer, and a second pair of edge couplers formed on the dielectric covering the first pair of edge couplers;

FIG. 7 is a cut-away side view of the embodiment of FIG. 6, illustrating the vertical displacement between the first pair of edge couplers and the second pair of edge couplers;

FIG. 8 is a cut-away top view of the embodiment of FIG. 6, illustrating a co-planar topology of a silicon-based optical waveguiding with the first pair of edge couplers;

FIG. 9 depicts an embodiment of the present invention utilizing a first plurality of several edge couplers formed on the oxide layer and a second plurality of edge couplers formed within the covering dielectric and positioned to overlap the first plurality of couplers; and

FIG. 10 includes a set of diagrams depicting, at a high level, an example process of forming silicon nitride edge couplers in accordance with the principles of the present invention.

### DETAILED DESCRIPTION

FIG. 1 shows an exemplary PIC structure 10 formed in accordance with the principles of the present invention to use SiN edge couplers directly formed on a buried oxide layer (a layer with a known high degree of planarity) in a manner where the SiN edge couplers are co-planar with the silicon device layer and the optical waveguides formed within the silicon device layer. In particular, PIC structure 10 is shown as comprising a substrate 12 upon which is formed an oxide layer 14. A relatively thin (compared to the thickness of oxide layer 14) silicon device layer 16 is formed over oxide layer 14. The combination of substrate 12, oxide layer 14, and silicon device layer 16 is a standard silicon-on-oxide (SOI) type of structure well-known in the art as a suitable choice for creating PICs. By virtue of the location of the oxide layer between the substrate and the silicon device layer, it has become referred to as a “buried oxide layer” (or, at times a “box”). Additional layers, such as metal interconnect layers 20-1, 20-2 are formed above silicon device layer 16, with dielectric material 18 (e.g., oxide) used to maintain separation between the elements as formed.

In accordance with the principles of the present invention, once silicon device layer 16 has been processed to form optical waveguides and other structures, edge portions of the silicon are removed (typically, etched) and replaced by one or more SiN edge couplers 26, which are formed on an exposed surface 14S of buried oxide layer 14. In the specific configuration of FIG. 1, a first SiN edge coupler 26-1 is shown as formed along a first side edge 22 of PIC 10 and a second SiN edge coupler 26-2 is formed along an opposing second side edge 24.

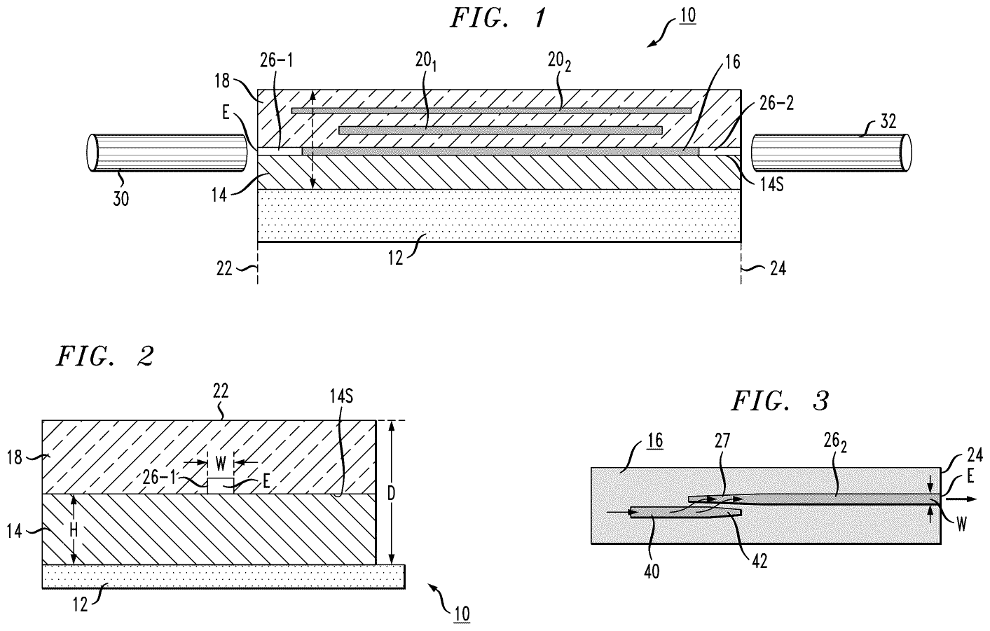

Inasmuch as the planarity of buried oxide layer 14 is significantly better than overlying dielectric 18 (as a result of oxide layer 14 being the initial material grown on substrate 12), it is possible to form SiN edge couplers on buried oxide layer 14 with a much smaller CD than the prior art couplers. Reference is made to FIG. 2, which is an end view of PIC 10 taken along edge 22. While not to scale, the exposed end E of SiN edge coupler 26-1 is depicted as having a width w of no greater than about 100 nm (as opposed to a CD limit of about 300 nm for prior art SiN edge couplers formed within dielectric 18 above silicon device layer 16), allowing for an optical beam exiting SiN edge coupler 26-1 to exhibit a larger mode field diameter. Also depicted in FIG. 2 is a height H of buried oxide layer 14 (which is on the order of a few microns), with SiN edge coupler 26-1 shows as formed directly on surface 14S of buried oxide layer 14. In this example embodiment, the width w of SiN edge coupler 26-1 is about 1% of the height H of buried oxide layer 14.

In many cases, the thickness of overlying dielectric 18 is controlled to be about the same as height H of buried oxide layer 14. In this manner, SiN edge coupler 26-1 is positioned in about the middle of the stack of layers, which may assist in the process of aligning an optical fiber (such as optical fiber 30 of FIG. 1) for optimum coupling.

FIG. 3 is a top-down view of a portion of silicon device layer 16 of PIC structure 10, showing an example placement of SiN edge coupler 26-2 with respect to a silicon waveguide 40 that has been formed within device layer 16. It is to be understood that only a portion of silicon waveguide 40 is included in this view. In accordance with the planar configuration of a SiN edge coupler and silicon waveguide in the present invention, an optical beam propagating along waveguide 40 will be evanescently coupled into SiN edge coupler 26-2. Preferably, waveguide 40 is formed to include a tapered end portion 42 and, similarly, SiN edge coupler 26-2 includes a tapered internal end portion 27. As shown, tapers 42 and 27 are disposed to be in close proximity to each other to assist in efficiently transferring the propagating beam between the two guiding structures. Inasmuch as conventional semiconductor processing techniques are used to create the waveguides and tapers, this topology is considered to be straightforward. The optical beam coupled into SiN edge coupler 26-2 at internal end portion 27 continues to propagate along within PIC structure 19, exiting along edge 24. The width W of SiN edge coupler 26-2 is also shown in FIG. 3.

Advantageously, the utilization of SiN edge couplers formed directly on the buried oxide layer does not preclude the possibility of also using a conventional SiN edge coupler formed in a region of overlying dielectric 18 above silicon device layer 16. FIG. 4 is a side view of an exemplary PIC structure 50 illustrating this embodiment. As with PIC structure 10 of FIG. 1, PIC structure 50 includes substrate 12 and buried oxide layer 14. A first set of SiN edge couplers 52-1 and 54-1 are shown as formed directly on exposed (by etching) surfaces of buried oxide layer 14 in the areas of edges 22 and 24, respectively. SiN edge couplers 52-1, 54-1 may be formed to exhibit the same relatively small CD (by virtue of the planarity of buried oxide layer 14) as SiN edge couplers 26 described above.

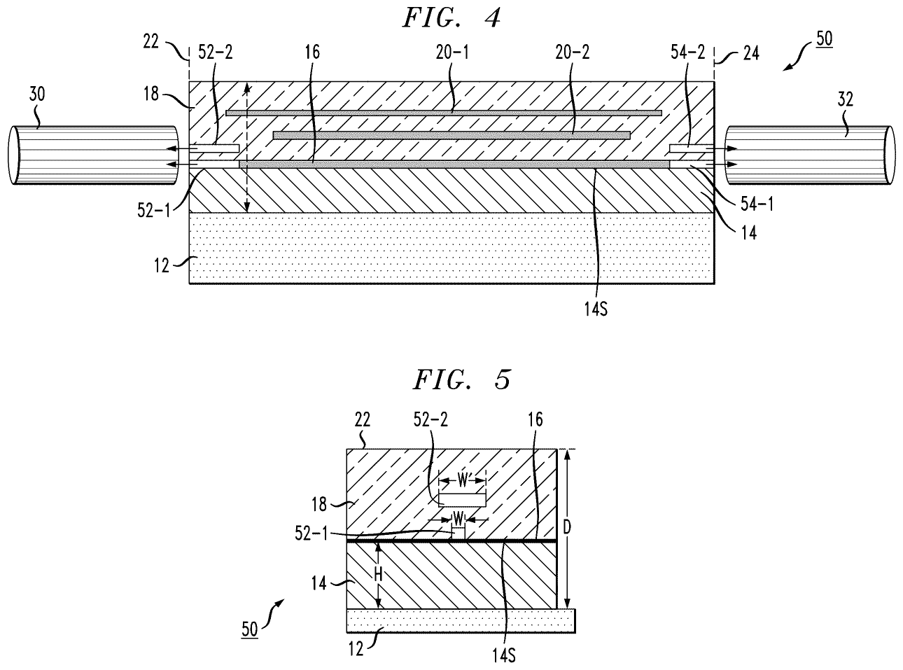

In this embodiment, a first layer of dielectric 18 is formed to cover SiN edge couplers 52-1, 54-1 and any other optical elements formed within silicon device layer 16. Using a conventional fabrication process, a second set of SiN edge couplers 52-2 and 54-2 is formed over first SiN edge couplers 52-1 and 54-1, respectively. FIG. 5 is an end view of PIC structure 50 taken along edge 22, illustrating the relative positions of SiN edge couplers 52-1 and 52-2. While not to scale, it is noted that inasmuch as second SiN edge coupler 52-2 is formed over the less planar dielectric material, its CD is somewhat larger (perhaps three times that of SiN edge coupler 52-1), requiring a larger minimal waveguide width w′ as well, which is associated with a smaller mode field diameter. Even so, the presence of an additional output beam may be desired some applications to illuminate a higher percentage of a core region.

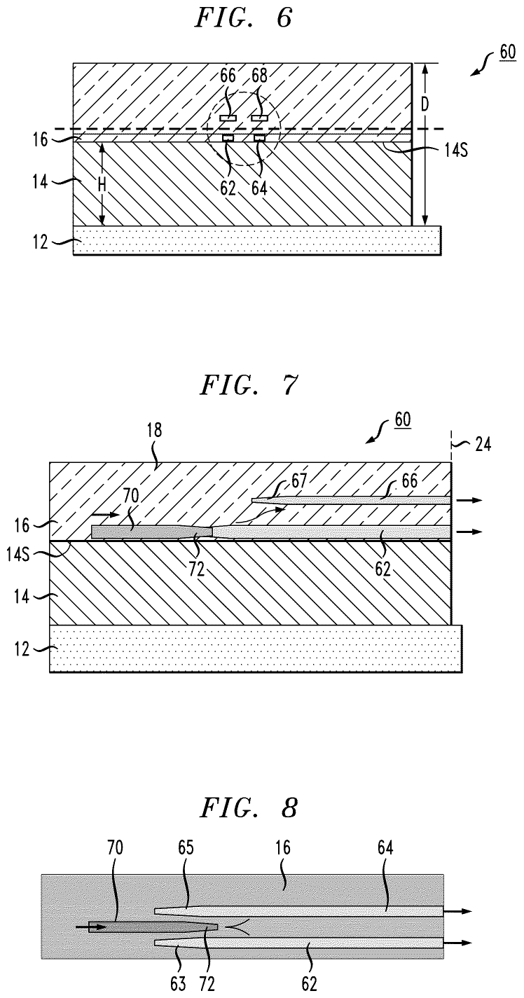

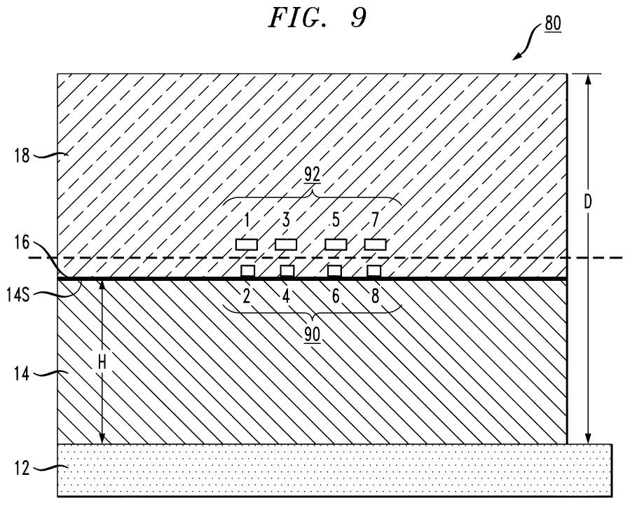

FIGS. 6-8 illustrate an extension of the embodiment of FIGS. 4 and 5, in this case utilizing a pair of SiN edge couplers in each layer of the coupling stack. That is, as shown in the view of edge 24 of FIG. 6, a pair of separate, spaced-apart SiN edge couplers 62, 64 are directly formed on surface 14S of buried oxide layer 14. Again, by virtue of the planarity of buried oxide layer 14, SiN edge couplers 62, 64 may be formed with a CD width on the order of no more than 100 nm or so. A second pair of SiN edge couplers, shown as couplers 66 and 68 are formed within dielectric material 18 above SiN edge couplers 62 and 64, respectively. FIG. 7 is a side view of a portion of PIC structure 60, illustrating optical beams exiting along edge 24. In the view of FIG. 7, an original optical beam propagates along a silicon waveguide 70, and is thereafter evanescently coupled into both co-planar SiN edge coupler 62 and elevated SiN edge coupler 66. FIG. 8 is a top view of silicon device layer 16, illustrating the position of silicon waveguide 70 between the pair of spaced-apart co-planar SiN edge couplers 62, 64.

In accordance with this particular configuration, therefore, the original beam propagating along silicon waveguide 70 will be evanescently coupled into all four SiN edge couplers 62, 64, 66, and 68. The co-planar pair 62, 64 may have the smaller width and associated larger mode field diameter than the elevated coupler pair 66, 68, but again there may be applications where it is desirous to have multiple output beams to fill more of the surface area of a core region.

Again, it is advantageous to utilize tapered waveguides to facilitate the evanescent coupling, and in FIG. 7 silicon waveguide 70 is shown as including a tapered termination 72. Elevated SiN edge coupler 66 is shown in this view as including a tapered internal termination 67. In the top view of FIG. 8, co-planar SiN edge couplers 62, 64 are shown as including internal tapers 63 and 65, respectively, with tapered termination 72 of silicon waveguide 70 shown as disposed between tapers 63 and 65.

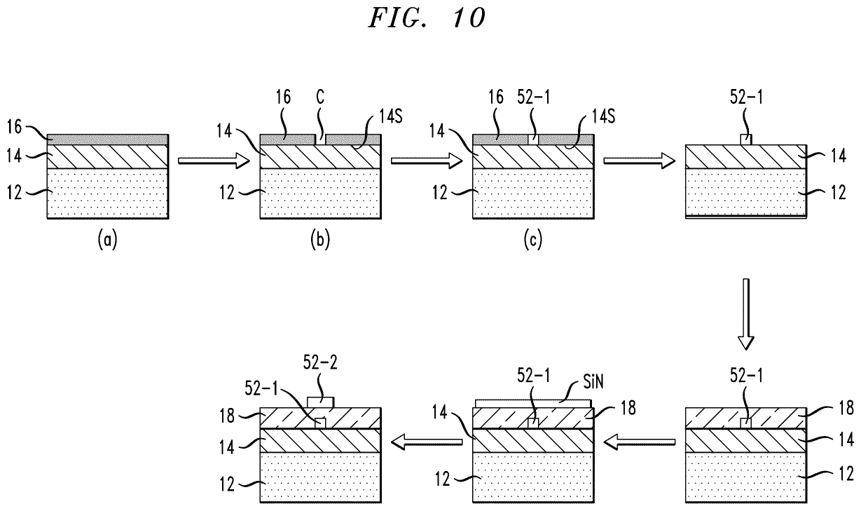

Mode matching between the inventive SiN edge couplers and an aligned optical fiber may be even further improved by utilizing an array of SiN edge couplers along both surface 14S of buried oxide layer 14 and above silicon device layer 16 (i.e., within dielectric 18). FIG. 9 illustrates an edge view of an exemplary PIC 80 includes a first array of SiN edge couplers 90 formed along surface 14S (and also co-planar with silicon waveguides formed within device layer 16) and a second array of SiN edge couplers 92 formed above device layer 16 within dielectric 18. Again, the couplers forming first array 90 may exhibit a smaller width than those of second array 92. However, in some cases of mode matching, it may be desirous to slightly enlarge the width of the couplers within first array 90 to improve the uniformity of the propagating mode.

As mentioned above, the processing steps associated with forming SiN edge couplers directly on the buried oxide layer are relatively straightforward and use conventional semiconductor processing techniques. FIG. 10 illustrates a set of possible steps that may be used to form the coupling arrangement of FIGS. 4 and 5, including a first SiN edge coupler 52-1 formed directly on buried oxide layer 14 and a second SiN edge coupler 52-2 formed within dielectric material 18 and disposed vertically above first SiN edge coupler 52-1.

A starting structure as shown in diagram (a) of FIG. 10 shows a provided semiconductor substrate 12, with buried oxide layer 14 formed (typically grown) over substrate 12 and a relatively thin silicon device layer 16 formed over buried oxide layer 14. The structure as shown in diagram (a) is then patterned to define the outline of SiN edge coupler 52-1, as shown in diagram (b). It is to be understood that the views of FIG. 10 are taken along edge 22 of the structure, where if viewed from above (such as the views of FIGS. 3 and 8), the etched pattern C would likely include a tapered region for optimum coupling efficiency with the silicon waveguides.

A layer of SiN material is then deposited, filling etched pattern C and provide the structure as shown in diagram (c). An etching process follows as shown in diagram (d) to remove any extraneous material in the vicinity of the deposited SiN, resulting in the formation of first SiN edge coupler 52-1. A portion of dielectric material 18 is then deposited over the structure (diagram (e)), and another layer of SiN is deposited over dielectric 18, as shown in diagram (f). This layer is subsequently patterned and etched to form second SiN edge coupler 52-2, as shown in diagram (g). As discussed above, the lower degree of planarity of dielectric 18 (associated with conformally covering elements such as first SiN edge coupler 52-1 and various silicon-based optic devices) results in the CD of second SiN edge coupler 52-2 being greater than that of first SiN edge coupler 52-1. The larger width w′ of coupler 52-2 corresponds, as a result, to a smaller MFD and a somewhat lower coupling efficiency than possible with first coupler 52-1.

While the principles of the present invention have been particularly shown and described with respect to illustrative and preferred embodiments, it will be understood by those skilled in the art that the foregoing and other changes in form and details may be made therein without departing from the spirit and scope of the invention, which should be limited only by the scope of the claims appended hereto.

What is claimed is:

1. An optical device, comprising:
a semiconductor substrate, defined as including opposing side edges;
an oxide layer formed on the substrate in a manner to extend the opposing side edges;
a silicon device layer formed on the oxide layer and processed to include at least one optical waveguide, with at least a portion of the silicon device layer removed along a side edge to expose the underlying oxide layer; and
a silicon nitride coupler for providing an optical signal path into and out of the optical device, the silicon nitride coupler disposed on the exposed portions of oxide layer along opposing side edges and in proximity with the at least one optical waveguide to provide evanescent coupling therebetween, the silicon nitride coupler and the optical waveguide having a co-planar geometry.

2. The optical device as defined in claim 1 wherein the silicon nitride coupler comprises a waveguide topology with a tapered first end termination adjacent to the optical waveguide.

3. The optical device as defined in claim 1 wherein the silicon nitride coupler is formed to have a minimal width along the side edge based on a critical dimension associated with a planarity of the oxide layer.

4. The optical device as defined in claim 3 wherein the minimal width of the silicon nitride coupler is no greater than 100 nm.

5. The optical device as defined in claim 1, further comprising one or more additional silicon nitride couplers formed at defined locations along opposing side edges of the structure.

6. The optical device as defined in claim 5, wherein the one or more additional silicon nitride couplers comprises a single additional coupler disposed in a spaced-apart relationship with the silicon nitride coupler, with the optical waveguide disposed in a region between the spaced-apart silicon nitride coupler and the second additional coupler.

7. The optical device as defined in claim 6 wherein the silicon nitride coupler and the single additional coupler are formed to include tapered end regions in proximity to the optical waveguide, promoting evanescent coupling therebetween.

8. The optical device as defined in claim 1, further comprising:
a layer of dielectric material disposed over the silicon nitride coupler and the silicon device layer; and
an upper silicon nitride coupler formed on an edge portion of the layer of dielectric material and disposed to overlap the silicon nitride coupler formed on the oxide layer, the upper silicon nitride coupler having a larger minimal width along a side edge than the silicon nitride coupler formed on the oxide layer, the larger minimal width associated with a reduced planarity of the layer of dielectric material with respect to the planarity of the oxide layer.

9. The optical device as defined in claim 8, further comprising
a first set of additional silicon nitride couplers disposed on the oxide layer; and
a second set of additional upper silicon nitride couplers formed on the layer of dielectric material and disposed to overlap with the first set of additional silicon nitride couplers.

10. A method of forming an optical device, comprising the steps of:
providing a semiconductor substrate defining as including opposing side edges;
forming an oxide layer of predetermined height over the semiconductor substrate and covering the semiconductor substrate to further extend the side edges upward;
forming a relatively thin silicon device layer over the oxide layer, the relatively thin silicon device layer including at least one optical waveguide;
patterning and etching defined regions of the silicon device layer along side edges thereof to expose a top surface of the underlying oxide layer, the defined regions in proximity to the at least one optical waveguide; and
depositing silicon nitride in the patterned and etched defined regions to form at least one silicon nitride edge coupler, providing evanescent coupling with the at least one optical waveguide into and out of the optical device.

11. The method as defined in claim 10, wherein the step of patterning and etching is implemented to create a plurality of defined regions for a plurality of separate silicon nitride edge couplers.

12. The method as defined in claim 10, further comprising the steps of:
depositing a dielectric material over the formed silicon nitride edge coupler and the at least one optical waveguide; and
forming an upper silicon nitride edge cover on a top surface of the dielectric material and disposed to overlap the silicon nitride edge coupler formed on the oxide layer.
